(19) United States
(12) Patent Application Publication
(10) Pub. No.: US 2015/0186936 A1
(43) Pub. Date: Jul. 2, 2015

(54) NETWORK GEOLOCATION DETERMINATION FOR DIRECT MAILINGS

(71) Applicant: Epic Playground, Inc., Dallas, TX (US)

(72) Inventor: Michael P. Sitarzewski, Dallas, TX (US)

(73) Assignee: Epic Playground, Inc., Dallas, TX (US)

(21) Appl. No.: 14/582,644

(22) Filed: Dec. 24, 2014

Related U.S. Application Data
(60) Provisional application No. 61/921,028, filed on Dec. 26, 2013.

(51) Int. Cl. G06Q 30/02

(52) U.S. Cl. CPC G06Q 30/0255

(57) ABSTRACT

Techniques for generating a direct mailing list based on visitors to a web page include storing multiple direct mailing lists, each direct mailing list being associated with a respective web page identifier. A request is made for a location of a device displaying the web page via a client-side script embedded in the web page. A set of geographic coordinates including a latitude coordinate and a longitude coordinate is received in response to the request. A property address corresponding to a parcel of property located at the set of geographic coordinates is determined based on the set of geographic coordinates and a deliverable address is determined based on the property address. The direct mailing list is identified based on the web page identifier of the web page and the deliverable address is added to the direct mailing list.

### CROSS-REFERENCES TO RELATED APPLICATIONS

This application claims the benefit of U.S. Provisional Patent Application No. 61/921,028, filed Dec. 26, 2013, entitled “NETWORK GEOLOCATION DETERMINATION FOR DIRECT MAILINGS,” the entire disclosure of which is hereby incorporated by reference for all purposes.

### BACKGROUND

1. The Field of the Invention

The present invention generally relates to direct mailing lists. More specifically, the present invention relates to generating a direct mailing list based on visitors to a web page.

2. The Relevant Technology

While online advertising has been widely adopted due to the relatively low cost and ease of reaching a broad audience, direct mail advertising is still desirable and can be more effective in certain situations. Direct mail advertising offers several advantages over online advertising. For example, online advertisement content is limited to digital media, such as text, images, videos and audio. These limitations do not apply to direct mail advertising and almost any physical object can be sent as a direct mail advertisement. Direct mail advertising can be especially effective when the advertisements are unique and targeted to a select audience.

### BRIEF SUMMARY

In one embodiment, a system for generating a direct mailing list based on visitors to a web page is presented. The system includes a client-side script embedded in the web page, a network attached storage, and a computer server system.

The client-side script is configured to request a location of a device displaying the web page. A set of geographic coordinates is received in response to the request. The set of geographic coordinates includes a latitude coordinate and a longitude coordinate. The set of geographic coordinates is transmitted to a computer server system and a web page identifier of the web page is also transmitted to the computer server system.

The network attached storage is configured to store a plurality of direct mailing lists. Each direct mailing list is associated with a respective web page identifier.

The computer server system further includes a network interface and a computer processor that is coupled to the network interface. The network interface is coupled to a network that includes the network attached storage. The network interface is configured to transmit data to and receive data from the network. The computer processor is configured to receive the set of geographic coordinates from the client-side script and determine a property address based on the set of geographic coordinates. The property address corresponds to a parcel of property located at the set of geographic coordinates. A deliverable address is determined based on the property address. The computer processor is further configured to receive the web page identifier from the client-side script and identify the direct mailing list from the plurality of direct mailing lists based on the web page identifier. The deliverable address is added to the direct mailing list associated with the web page identifier.

In another embodiment, a method for generating a direct mailing list based on visitors to a web page is presented. The method includes storing a plurality of direct mailing lists. Each direct mailing list is associated with a respective web page identifier. A request is made for a location of a device displaying the web page via a client-side script embedded in the web page. A set of geographic coordinates is received in response to the request. The set of geographic coordinates includes a latitude coordinate and a longitude coordinate. The set of geographic coordinates is transmitted to a computer server system and a web page identifier of the web page is also transmitted to the computer server system. A property address is determined based on the set of geographic coordinates. The property address corresponds to a parcel of property located at the set of geographic coordinates. A deliverable address is determined based on the property address and the direct mailing list is identified from the plurality of direct mailing lists based on the web page identifier of the web page. The deliverable address is added to the direct mailing list associated with the web page identifier of the web page.

In a further embodiment, a non-transitory computer-readable medium is presented. The non-transitory computer-readable medium has instructions stored therein, which when executed cause a computer to perform a set of operations including storing a plurality of direct mailing lists. Each direct mailing list is associated with a respective web page identifier. Additional operations include receiving a set of geographic coordinates from a client-side script embedded in a web page. The set of geographic coordinates includes a latitude coordinate and a longitude coordinate. A web page identifier of the web page is also received from the client-side script. A direct mailing list is identified from the plurality of direct mailing lists based on the web page identifier of the web page and a parcel centroid is determined for an address of the direct mailing list. The parcel centroid indicates a center of a parcel of property located at the address. A boundary is defined around the parcel centroid and it is determined that the set of geographic coordinates is located within the boundary. The address of the direct mailing list is verified based on determining that the set of geographic coordinates is located within the boundary.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an illustration of an exemplary environment for implementing one embodiment of a system for generating a direct mailing list based on visitors to a web page.

FIG. 2 is an interaction flowchart of one embodiment of a process for generating a direct mailing list based on visitors to a web page.

FIG. 3 is a flowchart of one embodiment of a process for adding an address to a direct mailing list.

FIG. 4 is a flowchart of one embodiment of a process for verifying an address of a direct mailing list.

FIG. 5 is an illustration of an example parcel of property for which a corresponding address can be verified.

FIG. 6 is an illustration of a user interface for managing direct mailing lists, according to an embodiment.

FIG. 7 is an illustration of embodiments of a special-purpose computer system and a computing device that can be used to implement a system for generating a direct mailing list based on visitors to a web page.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments described herein relate to systems and methods for generating a direct mailing list based on visitors to a web page. The generated mailing list includes physical addresses of users that visit the web page. The physical addresses can also be verified to be deliverable. Thus, the generated mailing list is targeted to users who have visited the web page and have verified deliverable addresses. This reduces the costs and increases the effectiveness of a direct mail advertising campaign. Furthermore, by combining direct mail advertising with online media (e.g., the web page), a unique advertising campaign can be created that engages users through multiple forms of communication. For example, an online user who shows interest in a particular product or service by visiting the web page can be retargeted through direct mail. A sample of the product or other physical materials can be sent to the user to create an experience that cannot be achieved through online advertising alone.

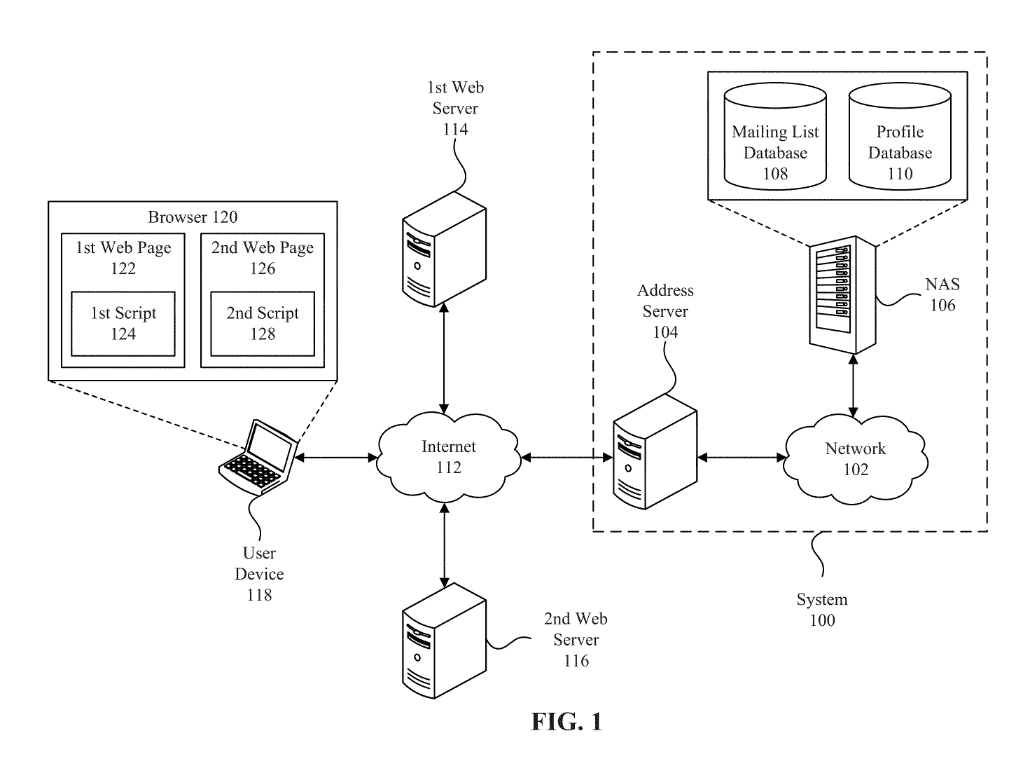

FIG. 1 is an illustration of an exemplary environment for implementing one embodiment of a system 100 for generating a direct mailing list based on visitors to a web page. System 100 includes several different components that communicate with each other through a network 102. Network 102 can be a private or public network and can include a local area network (LAN), a wide area network (WAN), a wired network, a wireless network, a telephone network, such as a cellphone network, the Internet, the World Wide Web, or any other desired network. Network 102 can use any desired communication and/or network protocols.

System 100 includes address server 104. Address server 104 can host different applications and services that perform the functions of embodiments described herein. For example, address server 104 can host one or more web pages or domains, scripts such as JavaScript for web browsers, back-end services for front end user interface applications such as native mobile applications, or cloud computing services. The applications and services handle all interactions with external computing devices that are not part of system 100. In other embodiments, address server 104 can be implemented as a computer server system that includes multiple servers, which can be located in a cluster at one physical site or spread out at remote physical locations.

System 100 also includes one or more databases that are maintained in a network attached storage (NAS) 106. NAS 106 stores data for system 100 that is used to generate direct mailing lists and perform other functions and features described herein. NAS 106 can be any type of storage device that is accessible over a network, including a storage area network (SAN). In other embodiments, NAS 106 and address server 104 can be implemented as part of one computer server system.

NAS 106 includes a mailing list database 108 that stores data relating to one or more direct mailing lists. For each mailing list, the data can include any combination of the following: addresses, a customer name or identifier that indicates the customer that the mailing list is for, a web page identifier that indicates the web page associated with the mailing list, timing parameters such as the period during which the mailing campaign is active and the frequency or dates for when mailers are sent out, one or more files that contain the images and texts of the mailers, and conditional triggers that indicate when a mailer should be sent. The web page identifier can be an identifier that is unique for a customer, a domain, or a web page. For example, the web page identifier can be the uniform resource locator (URL) of the domain or web page, or the identifier can be a randomly generated combination of characters and numbers that is assigned to the customer, domain, or web page. Conditional triggers can be used to automatically print and send mailers to one or more addresses if the conditions are met. Conditional triggers can include, for example, if a user visits a web page a certain number of times, if a user visits a web page during certain times of day or a period of days, if a user visits a certain number or combination of different web pages, or if the web pages are visited in a certain order. Additionally, conditional triggers can be used to print and send a batch of mailers for a certain number of addresses or periodically. For example, a batch of mailers can be sent when fifty new addresses have been added to a mailing list or weekly for new addresses added each week. The data for each mailing list can be generated by system 100 or defined by customers and inputted into system 100 through an interface such as a web page user interface or an application program interface (API).

NAS 106 can also include a profile database 110 that stores information regarding customers or addresses. For example, profiles can include login information such as a username and password and a profile can be stored for customers and end users. In some embodiments, when a customer accesses system 100, for example, through a web portal or user interface application, the customer is prompted to enter login information. System 100 can verify the login information by comparing the user provided information to information stored within profile database 110 to determine if the customer is authorized. Address information relates to physical addresses that have been collected by system 100. For example, a profile can include information relating to the users that reside at a physical address, such as names, ages, email addresses, phone numbers, interests, and preferences. The information can be retrieved from internet sources such as social media websites, public records, or web pages that the user has visited, for example, using third-party cookies. The information can also be provided by customers. In some embodiments, a user interface is provided to enable users to create an account and enter profile information for a physical address. An incentive can be provided to encourage such behavior. For example, the user will receive more relevant direct mail offers, coupons, or samples if the user provides personal information.

System 100 is connected to the internet 112 via address server 104. In other embodiments, the components of system 100 can be connected to the internet 112 via a gateway network device or router. A first web server 114, a second web server 116, and a user device 118 are also connected to the internet 112. It is understood that additional web servers and user devices can also be connected to the internet 112. The web servers are customer web servers that host web domains and pages for customers. User device 118 can be any computing device such as a smart watch, smart phone, tablet, laptop, or personal computer.

User device 118 executes a browser 120. Browser 120 displays a first web page 122 including a first script 124 and a second web page 126 including a second script 128. First web page 122 is retrieved from first web server 114 and second web page 126 is retrieved from second web server 116. In one embodiment, the scripts are embedded into the web pages such that the scripts are retrieved with the web pages from the web servers. For example, the scripts can be provided to the customers or the customers can download the scripts from address server 104. Furthermore, instructions can be provided to the customers for embedding the scripts into their web pages. In another embodiment, a link to the scripts is embedded into the web pages and the scripts are retrieved from address server 104 or another server of system 100 after the web pages are retrieved. In some embodiments, a web page identifier can also be embedded with the scripts in the web pages. The scripts can be two instances of the same script. The scripts communicate with address server 104 to perform the functions and features described herein.

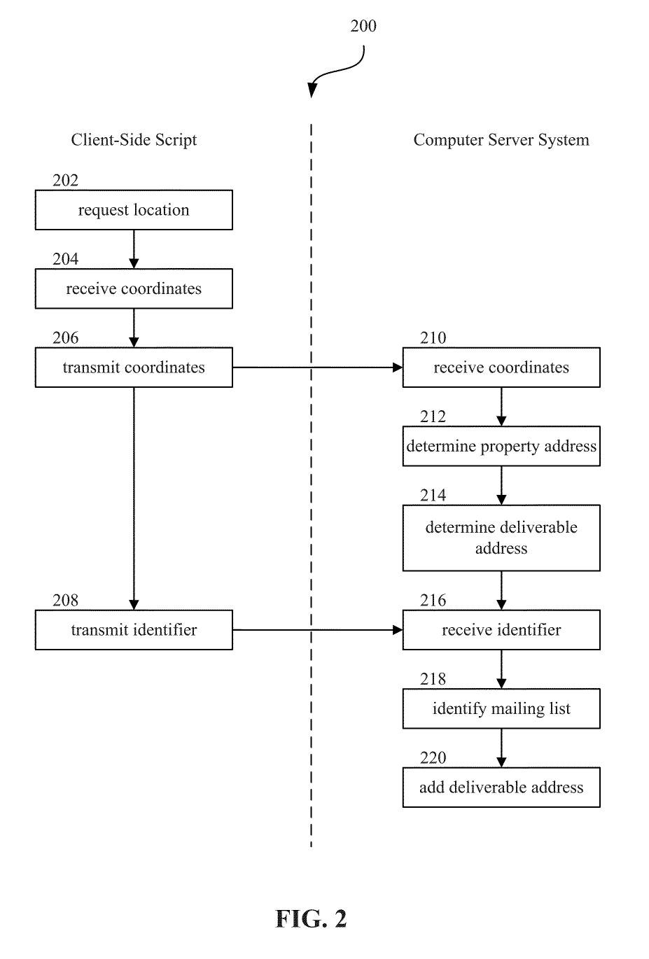

FIG. 2 is an interaction flowchart of one embodiment of a process 200 for generating a direct mailing list based on visitors to a web page. This flowchart illustrates the interactions between a client-side script and a computer server system. The client-side script is embedded into a customer's web page and executed by a browser on a user device. The client-side script communicates with the computer server system via a network, such as the internet.

At block 202, the client-side script requests the location of the user device. The request can be made, for example, through an API function provided by the browser or operating system of the user device. In one embodiment, a pop-up screen or some other user interface element can be used to display a message to the user requesting access to location data. At block 204, geographic coordinates are received as a response to the request. The geographic coordinates can be received from, for example, a global positioning system (GPS) module or assisted GPS (A-GPS) module of the user device. In one embodiment, the geographic coordinates are received from the GPS module or A-GPS module if the user grants access. If the user denies access, the geographic coordinates can be determined using alternative means, such as by using the internet protocol (IP) address of the device. The geographic coordinates include a longitude coordinate and a latitude coordinate. At block 206, the coordinates are transmitted to the computer server system. In one embodiment, the script also stores the geographic coordinates in a browser cookie on the user device. At block 208, a web page identifier is transmitted to the computer server system. The web page identifier identifies the web page that the script is embedded in.

At block 210, the computer server system receives the geographic coordinates from the client-side script. At block 212, the computer server system determines a property address based on the geographic coordinates. The property address corresponds to a parcel of property that is located at the geographic coordinates. The property address can be retrieved from, for example, property records maintained by assessor offices or third-party services that gather such records and other property data. At block 214, the computer server system determines a deliverable address based on the property address. The deliverable address can be determined by, for example, supplying the property address in an API call to services provided by the United States Postal Service (USPS) or other third-parties for verifying deliverable addresses.

At block 216, the computer server system receives the web page identifier from the client-side script. At block 218, a direct mailing list that is associated with the web page identifier is identified from a number of direct mailing lists that are stored in a database. In one embodiment, the direct mailing lists are indexed by the respective web page identifier that is associated with each list in the database. This allows a specific mailing list to be easily identified and retrieved based on the identifier that is associated with the list. After identifying the direct mailing list that is associated with the web page identifier, the deliverable address is added to the direct mailing list at block 220.

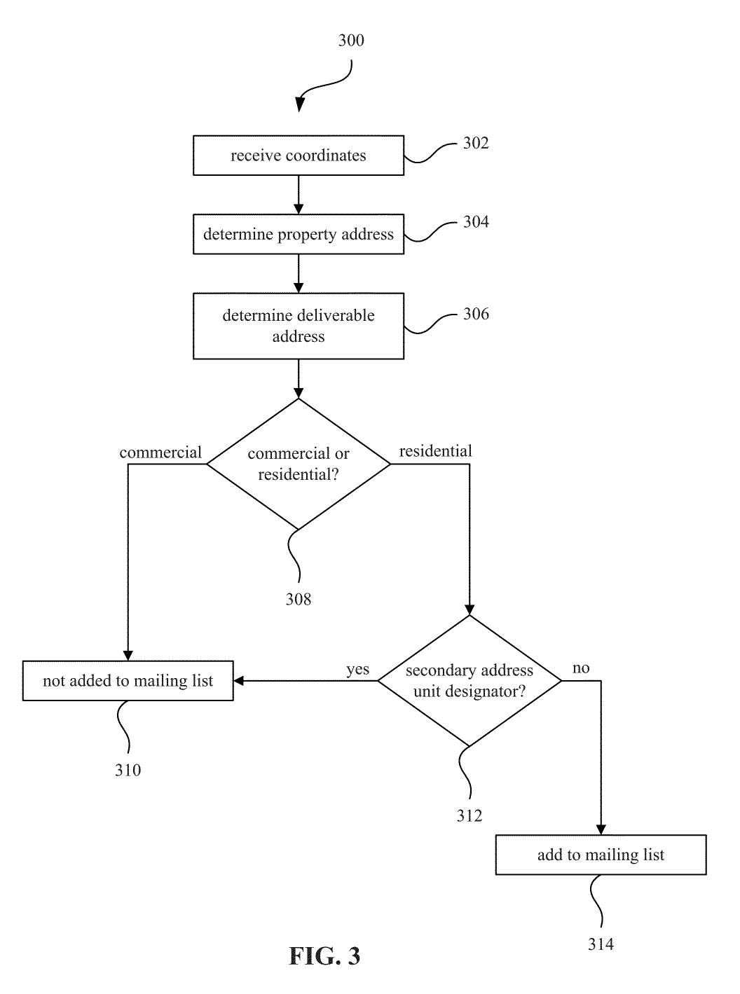

FIG. 3 is a flowchart of one embodiment of a process 300 for adding an address to a direct mailing list. Process 300 can be performed, for example, by a computer server system. At block 302, geographic coordinates are received. At block 304, a property address is determined using the geographic coordinates. At block 306, a deliverable address is determined using the property address. In this embodiment, additional information regarding the deliverable address is also retrieved using the property address. The additional information can include whether the address is a commercial address or residential address, whether a secondary address unit designator, such as a suite, unit, or apartment number, is required for the address, the county that the address is located in, and the congressional district of the address.

At block 308, the additional information is examined to determine if the deliverable address is a commercial or residential address. If the address is commercial, process 300 goes to block 310 and the address is not added to the direct mailing list. If the address is residential, it is determined whether a secondary address unit designator is required for the address at block 312. If a secondary address unit designator is required, process 300 goes to block 310 and the address is not added to the mailing list. If a secondary address unit designator is not required for the address, the address is added to the mailing list at block 314.

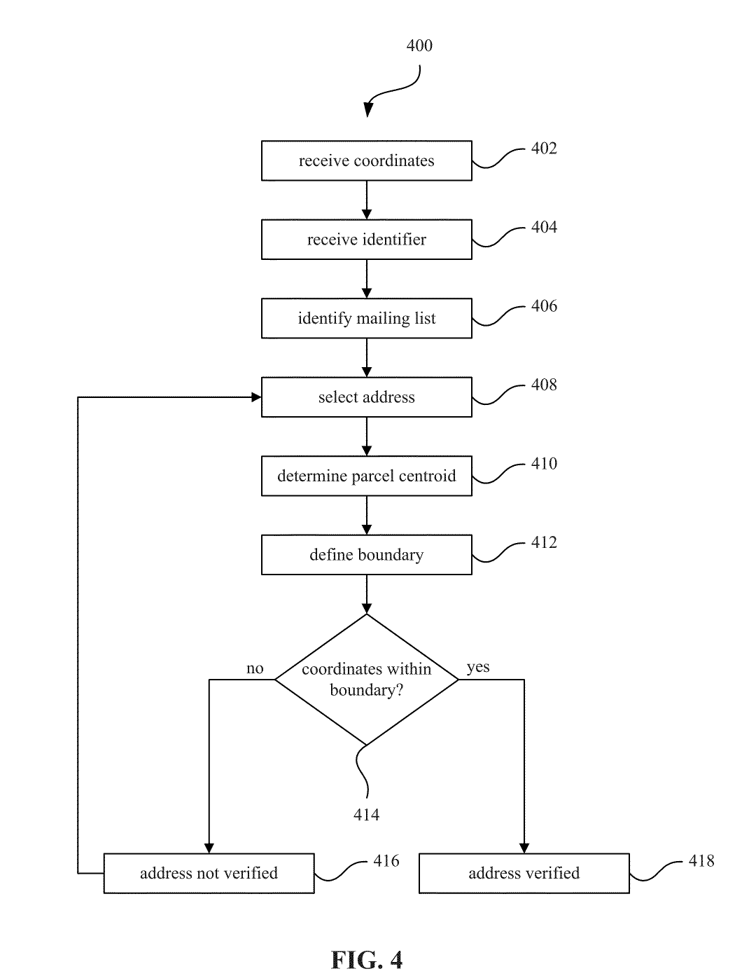

FIG. 4 is a flowchart of one embodiment of a process 400 for verifying an address of a direct mailing list. Process 400 can be performed, for example, by a computer server system to verify an address of a mailing list that is supplied by a customer or one generated by the system. As an address is verified each time a user visits a compatible web page, a certainty ranking can be increased or incremented to indicate the certainty of the address and data associated with the address. At block 402, geographic coordinates are received. At block 404, a web page identifier is received. At block 406, a direct mailing list is identified from a database using the web page identifier.

At block 408, an address is selected from the mailing list. At block 410, a parcel centroid is determined for the selected address. The parcel centroid is a set of geographic coordinates that correspond to the center of the parcel of property located at the address. In some embodiments, the selected address is verified to be deliverable or a deliverable address is retrieved based on the selected address, and the parcel centroid is determined using the deliverable address. At block 412, a boundary is defined around the parcel centroid. The boundary can have a predetermined shape and size. In a preferred embodiment, a circular boundary with a radius of 40 meters is defined around the parcel centroid such that the parcel centroid is at the center of the boundary. In other embodiments, the boundary can be in the shape of a polygon, such as a rectangle or hexagon, and can be defined to match the geographical boundary of the parcel of property. In further embodiments, the boundary size and shape can be variable based on factors such as how the geographic coordinates are obtained or the density of the population in the area of the address.

At block 416, it is determined whether the geographic coordinates are located within the boundary. If the coordinates are not within the boundary, the address is not verified at block 416 and process 400 returns to block 408 to select a new address from the mailing list. If the coordinates are located within the boundary, the address is verified at block 418. The address can be verified by, for example, setting a flag or storing some other form of a verified indication with the address in the database.

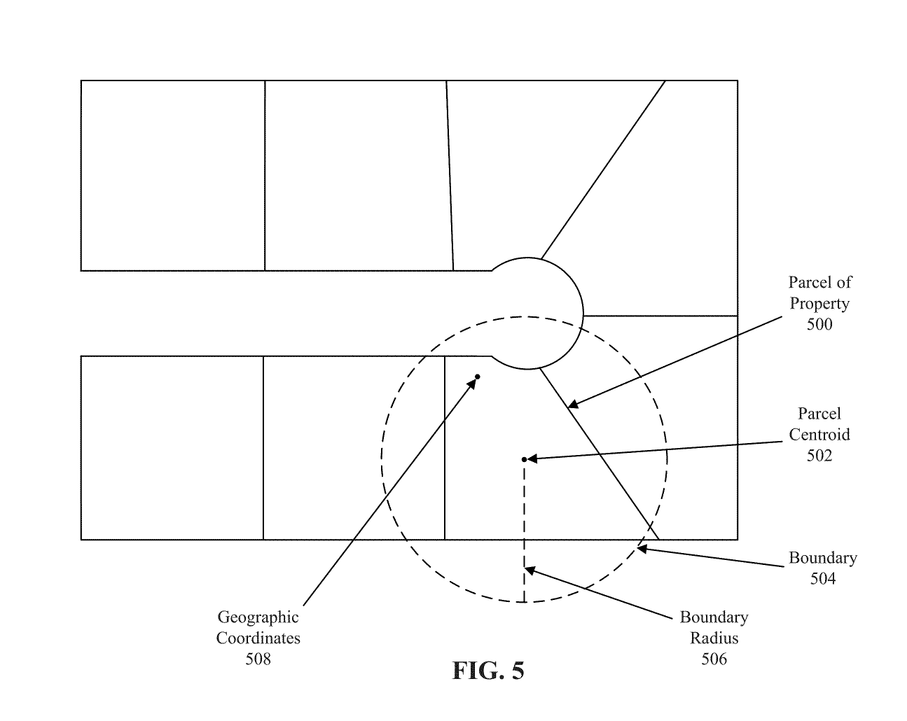

FIG. 5 is an illustration of an example parcel of property 500 for which a corresponding address can be verified. The parcel centroid 502 is the center of parcel 500. To verify the address of parcel 500, a boundary 504 having a certain boundary radius 506 is defined around the parcel centroid 502 such that the parcel centroid 502 is at the center of boundary 504. When a user visits a compatible web page and geographic coordinates 508 are determined for the user, the address is verified if the geographic coordinates 508 are located within boundary 504.

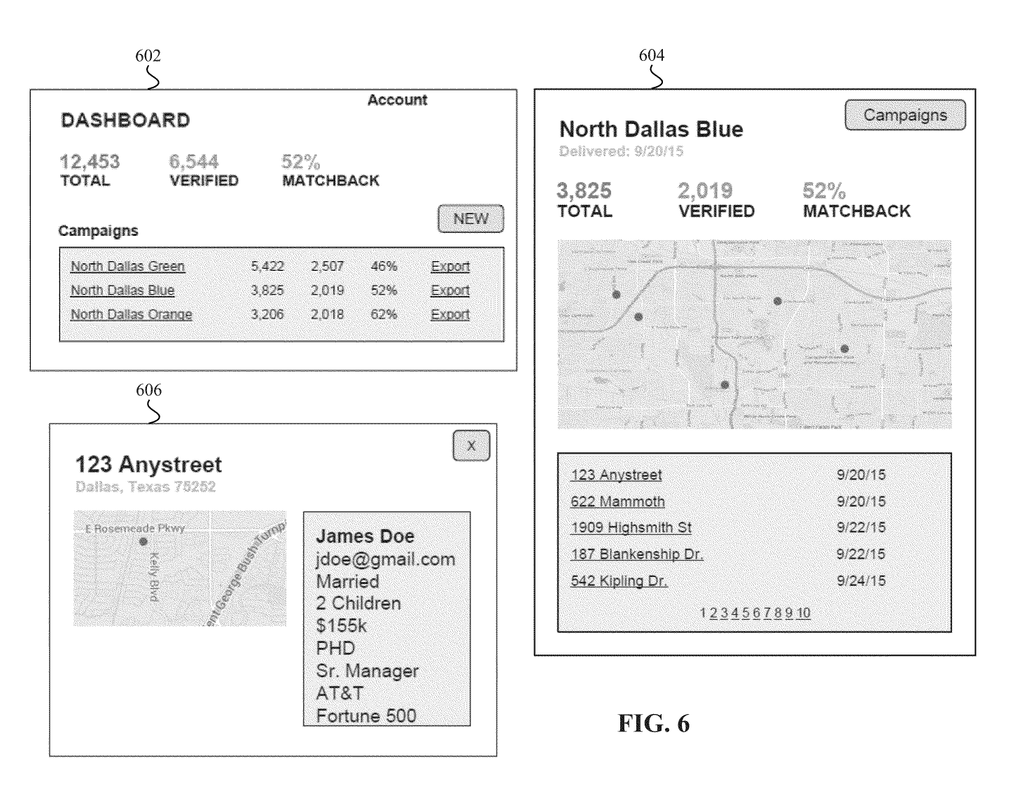

FIG. 6 is an illustration of a user interface for managing direct mailing lists, according to an embodiment. A dashboard screen 602 of the user interface provides buttons and links that customers can use to manage one or more direct mailing campaigns. The button allows a customer to create a new mailing campaign and links are provided for viewing the details of a campaign and exporting a list of all addresses or just the verified addresses for a campaign. Dashboard screen 602 can also display the total number of addresses, the number of addresses that have been verified, and the percentage of verified addresses across all mailing campaigns and for each mailing campaign.

Campaign screen 604 displays details for a particular campaign. The details can include addresses that have been verified and when a mailer was sent. Campaign screen 604 can also display a map with the verified addresses marked on the map to provide customers with a visual representation of the location of users. Each address also includes a link to an address screen 606 that displays details for a certain address. For example, the address screen 606 can display the names of the users that reside at the address, emails of the users, marital status, number of children, annual income, education level, title or profession, place of employment, and status or type of employer. Although not shown in the figure, additional screens can be provided for additional functions, such as uploading images and texts for mailers, editing mailers, and defining conditional triggers for mailers.

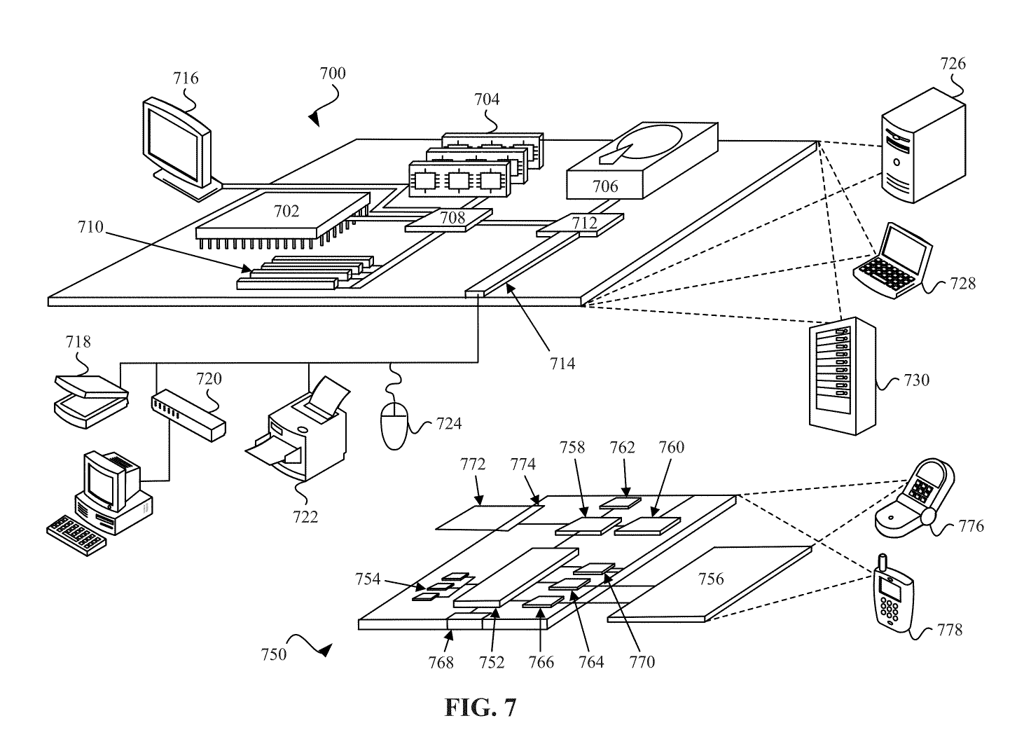

FIG. 7 is an illustration of embodiments of a special-purpose computer system 700 and a computing device 750 that can be used to implement a system for generating a direct mailing list based on visitors to a web page. Special-purpose computer system 700 represents various forms of digital computers, such as laptops, desktops, workstations, personal digital assistants, servers, blade servers, mainframes, and other appropriate computers. Computing device 750 represents various forms of mobile devices, such as personal digital assistants, cellular telephones, smart phones, tablets, laptops and other similar computing devices.

Computer system 700 includes a processor 702, random access memory (RAM) 704, a storage device 706, a high speed controller 708 connecting to RAM 704 and high speed expansion ports 710, and a low speed controller 712 connecting to storage device 706 and low speed expansion port 714. The components 702, 704, 706, 708, 710, 712, and 714 are interconnected using various busses, and may be mounted on a common motherboard or in other manners as appropriate. Computer system 700 can further include a number of peripheral devices, such as display 716 coupled to high speed controller 708. Additional peripheral devices can be coupled to low speed expansion port 714 and can include an optical scanner 718, a network interface 720 for networking with other computers, a printer 722, and input device 724 which can be, for example, a mouse, keyboard, track ball, or touch screen.

Processor 702 processes instructions for execution, including instructions stored in RAM 704 or on storage device 706. In other implementations, multiple processors and/or multiple busses may be used, as appropriate, along with multiple memories and types of memory. RAM 704 and storage device 706 are examples of non-transitory computer-readable media configured to store data such as a computer program product containing instructions that, when executed, cause processor 702 to perform methods and processes according to the embodiments described herein. RAM 704 and storage device 706 can be implemented as a floppy disk device, a hard disk device, an optical disk device, a tape device, a flash memory or other similar solid-state memory device, or an array of devices, including devices in a storage area network or other configurations.

High speed controller 708 manages bandwidth-intensive operations for computer system 700, while low speed controller 712 manages lower bandwidth-intensive operations. Such allocation of duties is exemplary only. In one embodiment, high speed controller 708 is coupled to memory 704, display 716 (e.g., through a graphics processor or accelerator), and to high speed expansion ports 710, which can accept various expansion cards (not shown). In the embodiment, low speed controller 712 is coupled to storage device 706 and low speed expansion port 714. Low speed expansion port 714 can include various communication ports or network interfaces, such as universal serial bus (USB), Bluetooth, Ethernet, and wireless Ethernet.

Computer system 700 can be implemented in a number of different forms. For example, it can be implemented as a standard server 726, or multiple servers in a cluster. It can also be implemented as a personal computer 728 or as part of a rack server system 730. Alternatively, components from computer system 700 can be combined with other components in a mobile device (not shown), such as device 750. Each of such devices can contain one or more of computer system 700 or computing device 750, and an entire system can be made up of multiple computer systems 700 and computing devices 750 communicating with each other.

Computing device 750 includes a processor 752, memory 754, an input/output device such as a display 756, a communication interface 758, and a transceiver 760, among other components. The components 752, 754, 756, 758, and 760 are interconnected using various busses, and several of the components may be mounted on a common motherboard or in other manners as appropriate. Computing device 750 can also include one or more sensors, such as GPS or A-GPS receiver module 762, gyroscopes (not shown), and cameras (not shown), configured to detect or sense motion or position of computing device 750.

Processor 752 can communicate with a user through control interface 764 and display interface 766 coupled to display 756. Display 756 can be, for example, a thin-film transistor (TFT) liquid-crystal display (LCD), an organic light-emitting diode (OLED) display, or other appropriate display technology. Display interface 766 can comprise appropriate circuitry for driving display 756 to present graphical and other information to the user. Control interface 764 can receive commands from the user and convert the commands for submission to processor 752. In addition, an external interface 768 can be in communication with processor 752 to provide near area communication with other devices. External interface 768 can be, for example, a wired communication interface, such as a dock or USB, or a wireless communication interface, such as Bluetooth or near field communication (NFC).

Device 750 can also communicate audibly with the user through audio codec 770, which can receive spoken information and convert it to digital data that can be processed by processor 752. Audio codec 770 can likewise generate audible sound for the user, such as through a speaker. Such sound can include sound from voice telephone calls, recorded sound (e.g., voice messages, music files, etc.), and sound generated by applications operating on device 750.

Expansion memory 772 can be connected to device 750 through expansion interface 774. Expansion memory 772 can provide extra storage space for device 750, which can be used to store applications or other information for device 750. Specifically, expansion memory 772 can include instructions to carry out or supplement the processes described herein. Expansion memory 772 can also be used to store secure information.

Computing device 750 can be implemented in a number of different forms. For example, it can be implemented as a cellular telephone 776, smart phone 778, personal digital assistant, tablet, laptop, or other similar mobile device.

It is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A system for generating a direct mailing list based on visitors to a web page, the system comprising:
a client-side script embedded in the web page, the client-side script being configured to:
request a location of a device displaying the web page,
receive a set of geographic coordinates in response to the request, the set of geographic coordinates including a latitude coordinate and a longitude coordinate,
transmit the set of geographic coordinates to a computer server system, and
transmit a web page identifier of the web page to the computer server system;
a network attached storage configured to store a plurality of direct mailing lists, each direct mailing list of the plurality of direct mailing lists being associated with a respective web page identifier; and
the computer server system that includes:
a network interface coupled to a network that includes the network attached storage, the network interface being configured to transmit data to and receive data from the network, and
a computer processor coupled to the network interface, the computer processor being configured to:
receive the set of geographic coordinates from the client-side script,
determine a property address based on the set of geographic coordinates, the property address corresponding to a parcel of property located at the set of geographic coordinates,
determine a deliverable address based on the property address,
receive the web page identifier from the client-side script,
identify the direct mailing list from the plurality of direct mailing lists based on the web page identifier, and
add the deliverable address to the direct mailing list associated with the web page identifier.

2. The system for generating the direct mailing list based on visitors to the web page of claim 1, wherein the set of geographic coordinates is received from at least one of a global positioning system (GPS) module and an assisted GPS (A-GPS) module of the device.

3. The system for generating the direct mailing list based on visitors to the web page of claim 1, wherein:
the network attached storage is further configured to store a plurality of profiles, each profile of the plurality of profiles being associated with a respective deliverable address; and
the computer processor of the computer server system is further configured to record an indication of a visit to the web page in a profile associated with the deliverable address.

4. The system for generating the direct mailing list based on visitors to the web page of claim 1, wherein the client-side script is further configured to:
store the set of geographical coordinates in a browser cookie on the device.

5. The system for generating the direct mailing list based on visitors to the web page of claim 1, wherein the web page identifier is a uniform resource locator (URL) of the web page.

6. The system for generating the direct mailing list based on visitors to the web page of claim 5, wherein the URL includes an email address, and wherein the computer processor of the computer server system is further configured to associate the email address with the deliverable address.

7. The system for generating the direct mailing list based on visitors to the web page of claim 6, wherein the email address is included in an Urchin Traffic Monitor (UTM) code in the URL.

8. A method for generating a direct mailing list based on visitors to a web page, the method comprising:
storing a plurality of direct mailing lists, each direct mailing list of the plurality of direct mailing lists being associated with a respective web page identifier;
requesting a location of a device displaying the web page via a client-side script embedded in the web page;
receiving a set of geographic coordinates in response to the request, the set of geographic coordinates including a latitude coordinate and a longitude coordinate;
transmitting the set of geographic coordinates to a computer server system;
transmitting a web page identifier of the web page to the computer server system;
determining a property address based on the set of geographic coordinates, the property address corresponding to a parcel of property located at the set of geographic coordinates;
determining a deliverable address based on the property address;
identifying the direct mailing list from the plurality of direct mailing lists based on the web page identifier of the web page; and
adding the deliverable address to the direct mailing list associated with the web page identifier of the web page.

9. The method for generating the direct mailing list based on visitors to the web page of claim 8, further comprising:
determining that the deliverable address is a residential address,
wherein the deliverable address is added to the direct mailing list associated with the URL of the web page based on determining that the deliverable address is the residential address.

10. The method for generating the direct mailing list based on visitors to the web page of claim 8, further comprising:
determining that the deliverable address does not require a secondary address unit designator,
wherein the deliverable address is added to the direct mailing list associated with the URL of the web page based on determining that the deliverable address does not require the secondary address unit designator.

11. The method for generating the direct mailing list based on visitors to the web page of claim 8, further comprising:
receiving an image file including an image for a mailer;
overlaying the image with the deliverable address; and
printing the image with the overlaid deliverable address.

12. The method for generating the direct mailing list based on visitors to the web page of claim 11, further comprising:
receiving a conditional trigger that is associated with the image file; and
determining that the conditional trigger is satisfied,
wherein the image with the overlaid deliverable address is printed based on determining that the conditional trigger is satisfied.

13. The method for generating the direct mailing list based on visitors to the web page of claim 12, wherein the conditional trigger includes a number of times that the web page has been visited on the device.

14. The method for generating the direct mailing list based on visitors to the web page of claim 12, wherein the image with the overlaid deliverable address is printed as part of a batch printing of the image, and wherein the conditional trigger includes a period of time that has elapsed since a previous batch printing of the image.

15. A non-transitory computer-readable medium, having instructions stored therein, which when executed cause a computer to perform a set of operations comprising:
storing a plurality of direct mailing lists, each direct mailing list of the plurality of direct mailing lists being associated with a respective web page identifier;
receiving a set of geographic coordinates from a client-side script embedded in a web page, the set of geographic coordinates including a latitude coordinate and a longitude coordinate;
receiving a web page identifier of the web page from the client-side script;
identifying a direct mailing list from the plurality of direct mailing lists based on the web page identifier of the web page;
determining a parcel centroid for an address of the direct mailing list, the parcel centroid indicating a center of a parcel of property located at the address;
defining a boundary around the parcel centroid;
determining that the set of geographic coordinates is located within the boundary; and
verifying the address of the direct mailing list based on determining that the set of geographic coordinates is located within the boundary.

16. The non-transitory computer-readable medium of claim 15, having further instructions stored therein, which when executed cause the computer to perform a set of operations comprising:
determining a percentage of addresses in the direct mailing list that has been verified.

17. The non-transitory computer-readable medium of claim 15, having further instructions stored therein, which when executed cause the computer to perform a set of operations comprising:
placing a marker on a map at a location corresponding to the verified address.

18. The non-transitory computer-readable medium of claim 15, having further instructions stored therein, which when executed cause the computer to perform a set of operations comprising:
generating a list of verified addresses from the direct mailing list.

19. The non-transitory computer-readable medium of claim 18, having further instructions stored therein, which when executed cause the computer to perform a set of operations comprising:
exporting the list of verified addresses to a file.

20. The non-transitory computer-readable medium of claim 15, wherein the boundary is a circular boundary with a radius of 40 meters.
